(19) United States
(12) Patent Application Publication
(10) Pub. No.: US 2022/0374116 A1
(43) Pub. Date: Nov. 24, 2022

(54) SYSTEMS AND METHODS FOR IMPROVED ANNOTATION WORKFLOWS

(71) Applicant: CLARIFAI, INC., Wilmington, DE (US)

(72) Inventors: Matthew Donald ZEILER, Fort Lee, NJ (US); Prasanna MESTHA, Byndoor (IN); Harmit MINHAS, Queens Village, NY (US); Yang SHENG, Forest Hills, NY (US)

(21) Appl. No.: 17/328,007

(22) Filed: May 24, 2021

(51) Int. Cl. G06F 3/0484; G06F 40/169

(52) U.S. Cl. CPC G06F 3/0484; G06F 40/169

(57) ABSTRACT

Systems, methods and computer program code are provided to perform an annotation workflow on an input and includes receiving information associated with an output from a model, the output generated based on application of the model to the input, identifying a first threshold model that applies to the information associated with the output, determining that the information associated with the output satisfies a threshold of the first threshold model, writing the output based on an action specified by the first threshold model, and updating an annotation user interface based on the action specified by the first threshold model.

### BACKGROUND

The fields of artificial intelligence and machine learning are increasingly impacting how organizations conduct business and research. An important aspect of implementing artificial intelligence and machine learning models is the development and training of those models. Often, the adoption of an artificial intelligence application requires substantial human interaction to perform tasks such as organizing content or training models. For example, one particular area that requires substantial effort is the review and annotation of input data for use in training or otherwise developing models.

One approach suggested by the assignee of the present application is to reduce the time and complexity of performing such annotations by automatically proposing annotations for adoption by human reviewers. It would further be desirable to provide systems and methods for automatically annotating inputs to substantially reduce the time and complexity of performing such annotations.

### SUMMARY

According to some embodiments, systems, methods and computer program code are provided to perform an annotation workflow on an input and includes receiving, information associated with an output from a model based on application of the model to the input, identifying a first threshold model that applies to the information associated with the output, determining that the information associated with the output satisfies a threshold of the first threshold model, writing the output based on an action specified by the first threshold model, and updating an annotation user interface based on the action specified by the first threshold model.

Pursuant to some embodiments, the model is a classification model and the information associated with the output includes a first concept and an associated first confidence score.

Pursuant to some embodiments, a user interface is operated to display the input, the pending annotation, and the score associated with the input to a user for confirmation, and the pending annotation is written as an annotation associated with the input upon confirmation from the user. In some embodiments, the input and the annotation are added to a training data set for the model upon confirmation from the user. In some embodiments, the annotation rule is updated based at least in part on at least one of (i) the pending annotation, (ii) the score associated with the input, and (iii) confirmation from the user. The annotation rule may be updated by updating training data associated with an annotation rule model.

A technical effect of some embodiments of the invention is an improved and computerized way of automatically annotating certain inputs and proposing annotations of other inputs to provide improved results when tagging and annotating large quantities of input data. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system pursuant to some embodiments.

FIG. 2 illustrates a process pursuant to some embodiments.

FIG. 3 illustrates a process pursuant to some embodiments.

FIG. 4 illustrates a process pursuant to some embodiments.

FIG. 5 illustrates a portion of a user interface that may be used pursuant to some embodiments.

FIG. 6 illustrates a portion of a rule datastore pursuant to some embodiments.

FIG. 7 is block diagram of an annotation platform pursuant to some embodiments.

### DETAILED DESCRIPTION

An enterprise may want to annotate large amounts of data for the purpose of organizing content or for training artificial intelligence (“AI”) models. By way of example, an enterprise that is developing a model to identify products in images may need to tag or “annotate” a large number of images to train and improve one or more models to identify those products. Unfortunately, such annotations can be time consuming and the amount of effort and time required to properly annotate a sufficient number of input images can impair the ability to train models that perform at a high degree of accuracy. It may therefore be desirable to provide systems and methods to improve the efficiency and throughput of annotation processing. Applicants have proposed systems and methods for proposing annotations in co-pending and commonly assigned U.S. patent application Ser. No. 17/224,362 (Attorney Docket No. C32.003) (filed on Apr. 7, 2021, the contents of which are hereby incorporated by reference in their entirety for all purposes). Applicants have recognized that it would further be desirable to provide systems and methods to automatically annotate certain inputs while suggesting other annotations to improve the efficiency and throughput of annotation processing. As used herein, the term “automated” or “automatic” may refer to, for example, actions that can be performed with little or no human intervention.

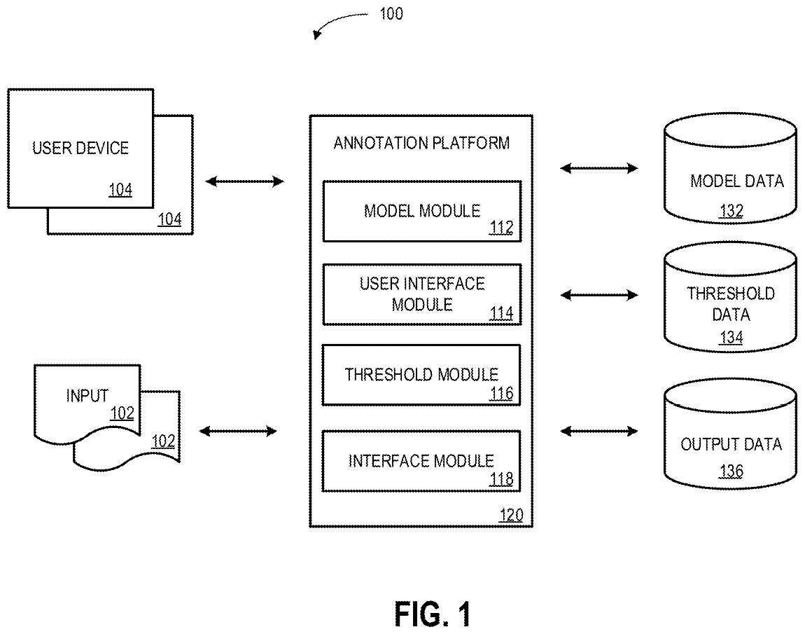

Features of some embodiments will now be described by first referring to FIG. 1 which is a block diagram of a system 100 according to some embodiments of the present invention. As shown, system 100 includes an annotation platform 120 which receives inputs 102 (such as images, videos or the like) and which produces outputs (stored as output data 136) such as annotations and other information associated with application of a model to the inputs 102. The system 100 allows one or more users operating user devices 104 to interact with the annotation platform 120 to perform annotation processing of those inputs 102 as described further herein. The annotation platform 120 includes one or more modules that are configured to perform processing to improve annotation efficiency and throughput, allowing users operating user devices 104 to quickly and accurately annotate large quantities of inputs 102. For example, pursuant to some embodiments, rules or threshold data 134 may be applied to information output from one or more models 132 to cause the automated annotation of certain inputs. In some embodiments, the rules or threshold data 134 may further be applied to provide suggested annotations to display to users operating user devices 104. Such automatic annotations and suggested annotations greatly improve the accuracy and efficiency of annotation workflows.

Pursuant to some embodiments, the system 100 includes components and interfaces that allow the generation and application of automated annotations as well as suggested annotations to users to improve the efficiency and throughput of annotation processing of inputs 102. The system 100 may generally be referred to herein as being (or as a part of) a “machine learning system”. The system 100 can include one or more models that may be stored at model database 132 and interacted with via a component or controller such as model module 112. In some embodiments, one or more of the models may be so-called “classification” models that are configured to receive and process inputs 102 and generate output data 136. As used herein, the term “classification model” can include various machine learning models, including but not limited to a “detection model” or a “regression model.” Embodiments may be used with other models, and the use of a classification model as the illustrative example is intended to be illustrative but not limiting. For example, embodiments may be used with desirable results in machine learning applications that use segmentation models. Segmentation models may be used, for example, to annotate masks on images or videos. Annotating data from such models can be very expensive if done by human annotators and embodiments may be used to reduce the cost and time associated with such annotations. Other examples of annotation applications that may use features of the present invention include three dimensional point clouds, LIDAR, synthetic aperture radar and other applications that are difficult, time consuming or expensive to perform using human annotators. As a result, the term “model” as used herein, is used to refer to any of a number of different types of models (from classification models to segmentation models or the like).

For clarity and ease of exposition, the term “concept” is used herein to refer to a predicted output of a model. For example, in the context of a classification model, a “concept” may be a predicted classification of an input. Embodiments are not limited to use with models that produce “concepts” as outputs—instead, embodiments may be used with desirable results with other model output types that are stored or written to a memory for further processing. For convenience and ease of exposition, to illustrate features of some embodiments, the term “confidence score” is used to refer to an indication of a model's confidence of the accuracy of an output (such as a “concept” output from a model such as a classification model). The “confidence score” may be any indicator of a confidence or accuracy of an output from a model, and a “confidence score” is used herein as an example. In some embodiments, the confidence score is used as an input to one or more threshold models to determine further processing actions as will be described further herein.

The present application includes an annotation platform 120 that includes (or interacts with) one or more models (such as classification models) that are configured to process input and provide predictions, and one or more subsystems that are configured to process the input as well as output from the models.

As an example, the annotation platform 120 may be configured to provide annotations for inputs 102 such as images or videos. For simplicity and ease of exposition, the term “image data” may be used herein to refer to both still images and videos. The annotations may be generated using one or more classification or other models as will be described further herein.

The annotation platform 120 may further include a threshold module 116 which interacts with threshold data 134 to apply one or more thresholds (e.g., via one or more thresholding models as will be described further below) to data output from one or more models from the model module 112. As will be described further below, in some embodiments, one or more thresholds or rules may be established that specify one or more conditions in which information output from a model (e.g., such as a concept predicted by a classification model when presented with an input 102) may be automatically handled (e.g., to automatically cause certain concepts to be annotated or not annotated). The thresholds or rules may also specify one or more conditions in which a concept output from a model may be suggested or proposed as annotations (e.g., for later confirmation by a user operating a user device 104). The thresholds or rules may further specify one or more conditions in which a concept output from a model should be ignored or otherwise not presented to a user operating a user device 104 (e.g., the concept predicted by the model is likely irrelevant to the current annotation workflow and a user operating a user device 104 should not be distracted or bothered by being presented with the concept). Each of these thresholds or rules allow an annotation workflow to proceed more efficiently and accurately, allowing large numbers of inputs to be processed.

In general, as used herein, the term “threshold” or “threshold data” refers to rules that are applied (e.g., via an associated model) to data associated with an input in a workflow. For example, a threshold may be a value or range of values associated with a confidence score output from a classification model. A threshold may be a binary value (e.g., such as one used to negate a concept output from a model), or a value used to scale an input. Further, a threshold may be a set of rules to cause an input image to be cropped or scaled based on information input to a threshold model. In general, a threshold is an operation on an input in a workflow. For convenience and ease of exposition, specific examples of thresholds and threshold models will be described herein in conjunction with an example related to classification models where the thresholds and threshold models are used in conjunction with confidence scores to achieve an automatic annotation workflow. Those skilled in the art will appreciate that the example is illustrative and not limiting and that other types of thresholds and threshold models may be used in conjunction with other workflows.

According to some embodiments, an “automated” annotation platform 120 may access threshold data in threshold database 134 as well as model data in model database 132 to automatically create or propose annotations as described further herein.

In some embodiments, a user device 104 may interact with the annotation platform 120 via a user interface (e.g., via a web browser) where the user interface is generated by the annotation platform 120 and more particularly by the user interface module 114. In some embodiments, the user device 104 may be configured with an application (not shown) which allows a user to interact with the annotation platform 120. In some embodiments, a user device 104 may interact with the annotation platform 120 via an application programming interface (“API”) and more particularly via the interface module 118. For example, the annotation platform 120 (or other systems associated with the annotation platform 120) may provide one or more APIs for the submission of inputs 102 for processing by the annotation platform 120.

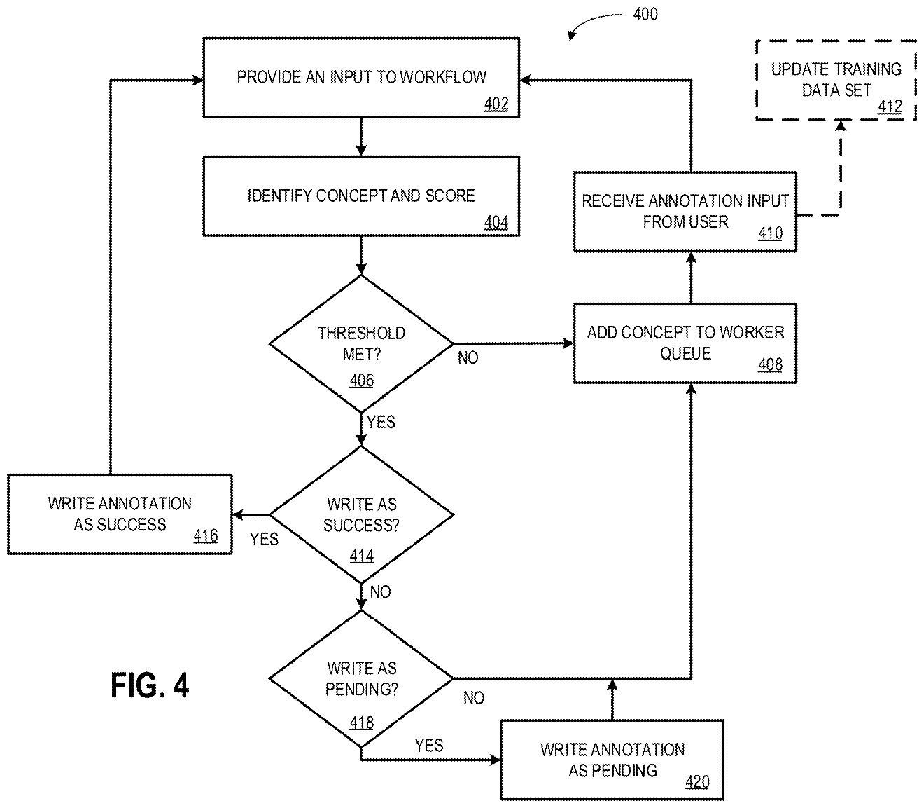

For the purpose of illustrating features of some embodiments, the use of a web browser interface will be described; however, those skilled in the art, upon reading the present disclosure, will appreciate that similar interactions may be achieved using an API. An illustrative (but not limiting) example of a web browser interface pursuant to some embodiments will be described further below in conjunction with FIG. 4.

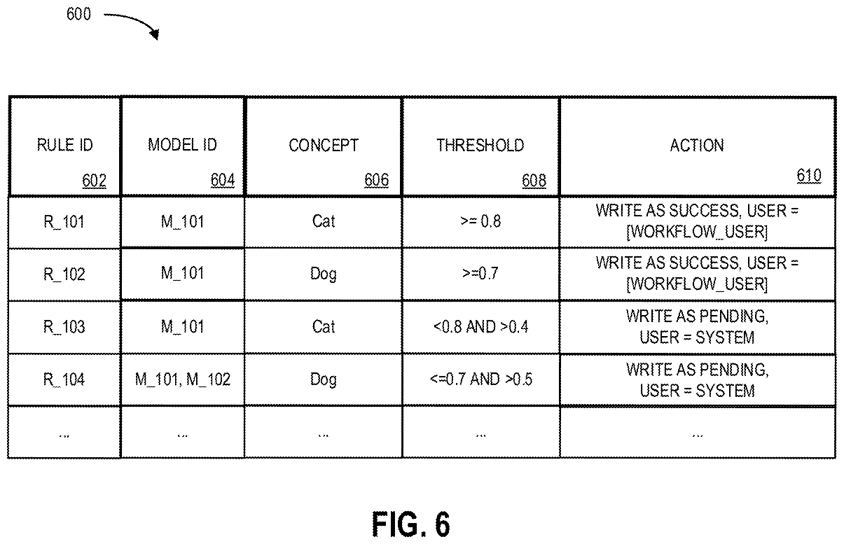

The system 100 can include various types of computing devices. For example, the user device(s) 104 can be mobile devices (such as smart phones), tablet computers, laptop computer, desktop computer, or any other type of computing device that allows a user to interact with the annotation platform 120 as described herein. The annotation platform 120 can include one or more computing devices including those explained below with reference to FIG. 6. In some embodiments, the annotation platform 120 includes a number of server devices and/or applications running on one or more server devices. For example, the annotation platform 120 may include an application server, a communication server, a web-hosting server, or the like.

The devices of system 100 (including, for example, the user devices 104, inputs 102, annotation platform 120 and databases 132, 134 and 136) may communicate using any communication platforms and technologies suitable for transporting data and/or communication signals, including any known communication technologies, devices, media, and protocols supportive of data communications. For example, the devices of system 100 may exchange information via any wired or wireless communication network such as the Internet, an intranet, or an extranet. Note that any devices described herein may communicate via one or more such communication networks.

Although a single annotation platform 120 is shown in FIG. 1, any number of such devices may be included. Moreover, various devices described herein might be combined according to embodiments of the present invention. For example, in some embodiments, the annotation platform 120 and threshold database 134 (or other databases) might be co-located and/or may comprise a single apparatus.

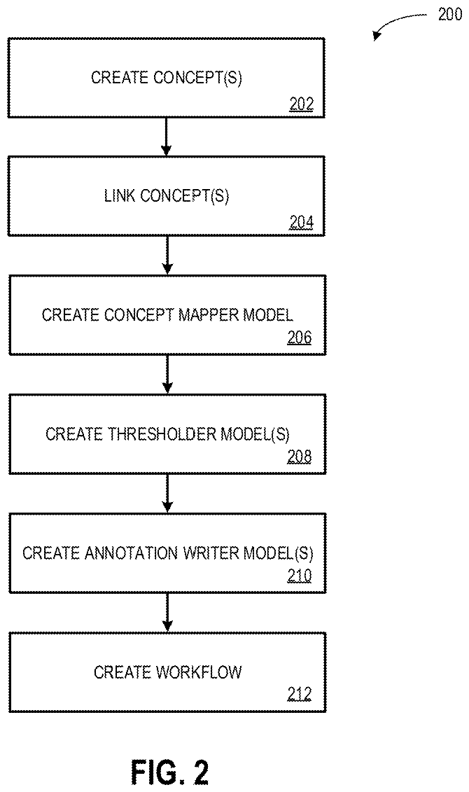

The system 100 may be operated to facilitate efficient and accurate annotation of input data. Prior to a discussion of an annotation workflow in conjunction with FIG. 2, a brief illustrative (but not limiting) example will first be introduced. In the illustrative example, an organization uses the system 100 of the present invention to annotate a large number of images. In particular, the organization uses the system 100 to identify animals and pets in a large number of photos. The organization creates a workflow in which the photographs are provided as the inputs 102 and chooses to use a classification model which is able to accurately identify when an animal or pet is in a picture. The classification model may also be able to predict a type of animal or pet (such as a “cat”, “dog”, etc.).

In the illustrative example, the organization has further specified rules dictating when a prediction by the model can be used to automatically annotate an input (thereby avoiding the need for a human to perform an annotation). For example, the organization may create a rule that a prediction of “cat” with a confidence score that is greater than 0.80 is to be automatically annotated, while a prediction of “cat” with a confidence score that is less than 0.80 but greater than 0.2 will be tentatively annotated (subject to further review), and a prediction of “cat” with a confidence score of less than 0.2 will not be automatically or tentatively annotated, and instead may be ignored or annotated as NOT a “cat”. The organization may establish a number of rules associated with the workflow. Any number of configurations may be provided to determine how an annotation should be further stored, updated, passed for review, etc. These “rules” may be expressed or implemented as models (referred to herein as “thresholder models”). Pursuant to some embodiments, the rules or conditions may be updated automatically by retraining or updating the thresholder models.

Reference is now made to FIG. 2 where an annotation workflow creation process 200 is shown that might be performed by some or all of the elements of the system 100 described with respect to FIG. 1 according to some embodiments of the present invention. The flow charts and process diagrams described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

In some embodiments, an annotation platform 120 may allow users to create “applications” or “workflows” which specify how inputs are to be processed. Workflows or applications may invoke other workflows (for example, workflows may be nested or chained). In some embodiments, a workflow may simply be a single model which, for example, receives an input and makes a prediction based on the input. In some embodiments, a workflow may be an annotation workflow which allows some or all inputs to be annotated using an automated workflow process. The process 200 of FIG. 2 depicts an embodiment which may be used to create such an automated annotation workflow. The process 200 of FIG. 2 may be performed via a user interface (e.g., by a user interacting with a user interface of a user device 104) or via an API associated with the annotation platform 120. For simplicity and ease of exposition, the process 200 will be described as being configured via a user interface (although those skilled in the art will appreciate that each step may be performed via an API or the like).

Process 200 begins at 202 where the user interacts with the annotation platform to create one or more concepts for use in the application and the workflow. For example, in the illustrative example introduced above, the concepts of “cat” and “dog” may be created. Processing continues at 204 where the concepts created at 202 are linked to a model used in the application for which the workflow is being created. For example, in some embodiments, applications may be created with one or more models. Continuing the illustrative example, the model in the application for which an annotation workflow is being created is a general classification model. The general classification model has a set of concepts associated with it. Processing at 204 involves linking the workflow concepts (created at 202) with the already-established concepts that will be output by the general classification model.

Processing continues at 206 where a concept mapper model is created. The concept mapper model is a model that will translate the concepts from the general model to the concepts created at 202. In some embodiments, the concept mapper model will map the concepts as different types (where the type indicates the type of relationship the concept has to the general model concepts). For example, the concept types may include synonyms, hypernyms and hyponyms, although other types of relationships may also be used. Each concept created at 202 will have a type. In some embodiments, a type of “synonym” is used as a default unless otherwise specified.

Processing continues at 208 where one or more thresholder models are created. Pursuant to some embodiments, thresholder models may be created that apply one or more rules or thresholds to data associated with outputs of models in the workflow. For example, the one or more thresholder models may establish thresholds that are applied to the concepts output from a model. More particularly, the thresholder models may establish thresholds that are applied to confidence scores that are associated with the concepts output from a model (although other rules or thresholds may also be used). In some embodiments, different types of thresholder models may be configured including, for example, a “greater than” thresholder and a “less than” thresholder. Those skilled in the art, upon reading the present disclosure, will appreciate that other comparison type operations may be used on data output from models in the workflow. When the thresholder models are created, the thresholds may be defined for each concept created at 202.

Processing continues at 210 where one or more annotation writer model(s) are created. Each annotation writer model may receive the data object from the output of the model which may include data such as concepts, regions or bounding boxes, confidence scores, mapped concepts, etc. The annotation writer model may apply a write action to write the data object along with a status and information identifying an author or annotator of the object. For example, an annotation writer model may be created which writes a status of “ANNOTATION_SUCCESS” as well as information identifying the author as the application owner. In this way, for annotations that are automatically created (e.g., when the classification model identified a concept with a high degree of confidence and that concept is mapped to a concept in the application), the concept can be written as an annotation without human intervention. Different annotation writer statuses may be created and written. For example, an annotation writer model may be created which writes a status of “ANNOTATION_PENDING” as well as information identifying the author as the application owner. In this way, concepts that are identified with a reasonably high degree of confidence (but not sufficiently high to result in an annotation success), may be written with a pending status which may be used to trigger further review in the workflow. In some embodiments, each annotation writer model may define a status to be written as well as an author of the annotation. Other data attributes may also be created to facilitate further workflow actions.

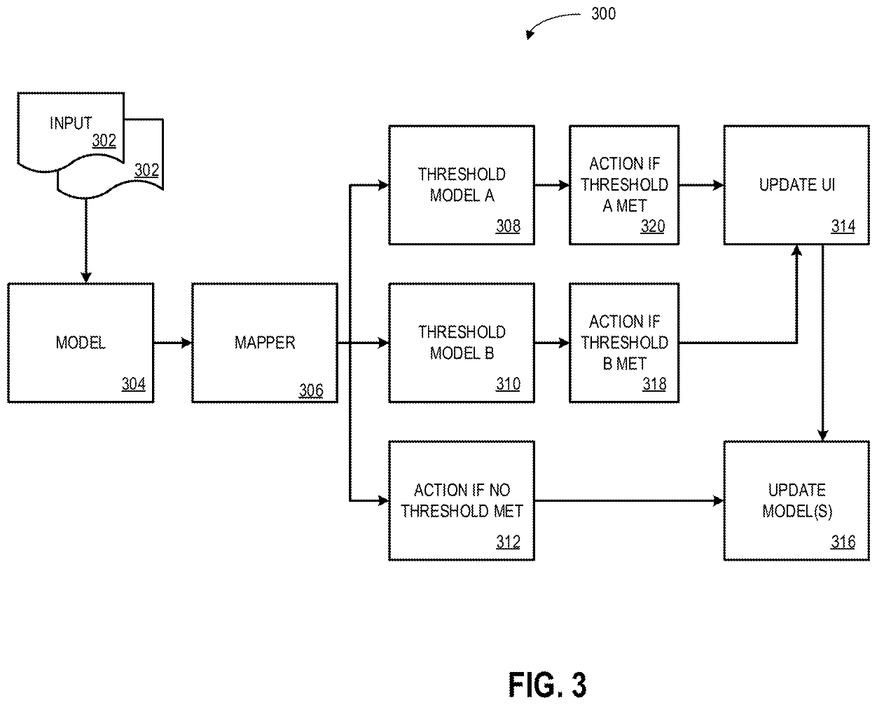

Processing continues at 212 and the workflow is saved and created for use. The workflow may now be used to implement an improved annotation workflow which may substantially reduce the amount of human effort, time and expense required to create annotations. Processing at 212 causes all of the models (the application model, the mapper model, the thresholder models, the writer models, etc.) to be connected together in a single workflow. The operation of the workflow will now be described by reference to FIG. 3.

Reference is now made to FIG. 3 where an annotation workflow process 300 is shown that might be performed by some or all of the elements of the system 100 described with respect to FIG. 1 according to some embodiments of the present invention. Pursuant to some embodiments, the annotation workflow process 300 is performed after a workflow has been created (e.g., such as after step 212 of FIG. 2). The flow charts and process diagrams described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

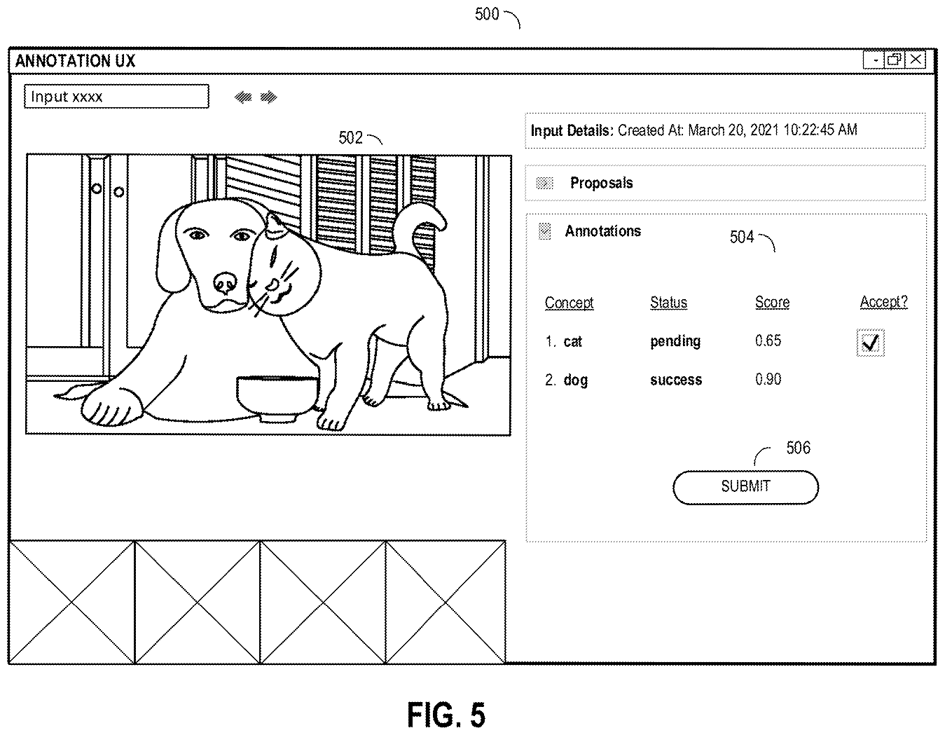

The workflow annotation process 300 will be described using the illustrative example introduced above and in which a user has configured the process to support the annotation of animal and pet images. Further, the process 300 will be illustrated by reference to the user interface of FIG. 5 and the illustrative data store of FIG. 6. Continuing to refer to the illustrative example introduced above, the workflow annotation process 300 uses a classification model 304 that has been trained to identify objects in an image. Referring briefly to FIG. 5, the input 302 to the process 300 may be an image showing a cat and a dog (shown as item 502 of FIG. 5), and the process 300 may cause annotations to be automatically generated for those inputs (or at least generate a user interface that may be used to efficiently select annotations for use with those inputs).

In the embodiment depicted in FIG. 3, a single workflow is shown. In some embodiments, multiple workflows or applications may be nested or chained together. In the embodiment depicted, an application has a workflow that has a model 304 that receives one or more inputs 302. In the illustrative example, the model 304 is a classification model. More particularly, the model is a general classification model that has been configured for use in the workflow. Every input 302 will be predicted by the model 304 to generate embeddings. The output of the model 304 (e.g., concepts with prediction values) will be passed to a mapper 306 to map the concepts form the model 304 (e.g., such as a general model associated with the workflow) to concepts within the workflow or application. The mapped concepts output from the mapper 306 are presented to one or more threshold models 308, 310. The greater than threshold model (e.g., model “A” 308) will pass concepts and their prediction values to an action 320 if information associated with a concept and its prediction value are greater than the value defined in the threshold model A 308 configuration. The action 320 may be a write action such as, for example, an action to cause the concept to be automatically written as an annotation such that no human review is required. Further, the action 320 may specify that the annotation be written with a specific pre-defined user or username.

The less than threshold model (e.g., model “B” 310) will pass concepts and their prediction values to an action 318 if information associated with a concept and its prediction value is less than a threshold associated with the model 310. Further, if a concept and its predication value does not meet either threshold model 308 or 310, a further action may be taken. The thresholds and actions may be configured in a number of different ways, and the configuration depicted in FIG. 3 is for illustrative purposes only. For example, the thresholds are described as “greater than” and “less than” thresholds. Other types of rules or thresholds may be defined (such as rules or thresholds that scale an input, that perform a boolean operation, that create or modify a bounding box on an input, etc.)

In the illustrative example introduced above, a set of thresholds or annotation rules have been created in association with the workflow 300. In some embodiments, sets of thresholds or rules may be associated with an application or may be selected from standardized sets of thresholds or rules. In the illustrative example, the output from the model 304 in the workflow 300 may be applied to one or more threshold models 308, 310 associated with the workflow to determine what further processing should be performed on the input. For example, continuing the illustrative example, the concept “cat” may be output from the model 304 along with a confidence score of 0.65, while the concept “dog” may be output from the model 304 in the workflow 300 along with a confidence score of 0.90. In practical use, the workflow may include a number of thresholds (and threshold models for applying those thresholds) and may establish rules associated with a number of concepts and corresponding confidence scores. Further, the workflow 300 may include multiple models 304 or other applications which output data for use in generating concepts for use in comparing to the threshold models.

The threshold models may apply a number of thresholds or rules such as those shown in FIG. 6. Examples of an illustrative database that might be used in connection with the annotation platform 120 are shown in FIG. 6. Note that the database described herein is only an example, and additional and/or different information may be stored therein. Moreover, various databases might be split or combined in accordance with any of the embodiments described herein.

Referring to FIG. 6, a table 600 is shown that represents the threshold database 134 that may be part of the system 100 of FIG. 1. The table 600 may include, for example, entries identifying rules that may be applied to model output data in a workflow pursuant to some embodiments. For example, the thresholds may include information such as a threshold or rule identifier 602, information identifying one or more models 604 that the threshold 602 is associated with, information identifying one or more concepts 606 that may invoke the threshold 602, and information identifying one or more actions 610 to be taken if the threshold is satisfied. The data in the table 600 may be created by a user during the workflow creation process 200 (as described above in conjunction with FIG. 2) or during another process.

As an example of the data shown in table 600, a threshold rule R_101 may be established to operate on the output of a model identified as model M_101. If the model outputs a concept 606 of “Cat” (or if the concept “Cat” is mapped in the workflow using a mapper 306), then the threshold 608 is to be applied (to check whether the confidence score associated with the concept “Cat” is greater than or equal to 0.8). If the threshold is met, then an action 610 is taken. In the example data, the action is to write the annotation as a “success” using a username of the workflow user. A number of different thresholds may be configured together to cause different actions to be performed in an annotation workflow. For example, in addition to automatically writing concepts as successful annotations (and thereby avoiding or reducing the need for a human to review), concepts may be written as “pending” so that a human or some other review may be performed. As described above, embodiments are not limited to thresholds applied against confidence scores. Instead, a wide variety of different types of thresholds or rules may be applied (e.g., such as to scale an input, to apply a bounding box, or the like). In some embodiments, actions 610 may include causing a model (such as a model 604) to be retrained using a concept. Further, in some embodiments, one or more threshold models may be retrained (e.g., as a result of an action 610), allowing the thresholds to be automatically updated based on the performance of the workflow. As an illustrative example, if a classification model (such as model 304) in a workflow consistently identifies “cats” with a confidence of 0.75 (which would create a “pending” annotation using the thresholds shown in FIG. 6), but then users confirm those annotations (causing them to be written as a success after user review), the system of the present invention may automatically cause the greater than threshold model to change the threshold for that concept to be >=0.75.

Those skilled in the art, upon reading the present disclosure, will appreciate that other rules and information may be stored in or associated with a rules or threshold datastore for use with the present invention. The tabular representation of a portion of a datastore is not intended to imply that a relational data store is needed—those skilled in the art will appreciate that any of a number of different data storage techniques may be used to store, retrieve, and apply rules and thresholds pursuant to the present invention.

Referring again to FIG. 3, when data output from the model 304 is compared with the threshold models 308, 310, one of several processing paths can be followed. For simplicity, the data output from the model 304 may be referred to herein as consisting of a concept (e.g., a prediction from the model) and a confidence score. However, those skilled in the art will appreciate that other data may be output from the model 304 (and may be used in conjunction with rules or thresholds to determine if an annotation should be automatically created or if some other action(s) should be taken). As an example, the output from model 304 may include a list of predicted concepts such as, for example, the concept of a “dog” and the concept of a “cat”. The confidence score associated with the dog prediction may be 0.9 and the confidence score associated with the cat prediction may be 0.65. The concepts from the model 304 may be mapped to the concepts present in the workflow using a mapper 306.

Then, the concepts and associated data (here, the associated confidence scores) are presented as inputs to one or more threshold models 308, 310. When the dog concept with the confidence score of 0.9 is presented, the greater than threshold model 308 is satisfied (as shown in FIG. 6, a dog concept with a confidence of greater than 0.7 passes the threshold), and the corresponding action is taken (which happens to be “WRITE AS SUCCESS” as the workflow username. That is, the annotation of “dog” is automatically written as an annotation. The cat prediction is also presented to the inputs of the threshold models 308, 310. However, the cat confidence score is below the threshold to write as success. Instead, the cat confidence score is greater than a lower threshold (shown as R_103 in FIG. 6) causing the action of “WRITE AS PENDING” to be taken (where the PENDING is written from the SYSTEM username). In some embodiments, PENDING annotations may be presented in a user interface 314 for display to the user so that the user can accept or decline the proposed PENDING annotation for the input 302.

If either of the concepts failed to meet the thresholds for any of the threshold models 308, 310, then an action 312 will be taken. As an example, the action may be to ignore the concept (and specifically not use it as an automated annotation and not use it as a pending annotation as it would be a waste of user time). In some embodiments, the action may result in an update of a user interface such as the user interface 500 of FIG. 5. In this way, the system 100 automatically annotates the input and reduces the amount of effort and time required to perform the annotation.

In some embodiments, the threshold models 308, 310 may be modified for one or more annotation rules in a workflow. For example, in a workflow or application to annotate inputs having a large number of “cat” or “dog” images, the model may determine that the threshold 608 specified for the “dog” concept is too restrictive (e.g., too many inputs are being annotated as “pending” and those “pending” annotations are being accepted by users). As a result, the model (or rules) may be modified to adjust the threshold data 600 to allow more “dog” objects to be automatically annotated. In this manner, embodiments allow workflows to be dynamically adjusted to further increase the efficiency of the annotation processing.

In some embodiments, automated annotations (e.g., annotations that written as “SUCCESS” may not need further review by a user and as such are not displayed in a user interface. In some embodiments, such annotations may be displayed on a user interface for informational purposes. For example, referring to FIG. 5, the user interface 500 includes information about the input (including a display of the image 502) as well as information identifying the concepts identified by the model (shown as screen area 504). The screen area 504 may show the concepts, the status (whether the concept was successfully used as an annotation or whether the concept is pending review by the user) and a button or other user interface elements that allow a user to accept or reject any pending annotations.

In the example shown in FIG. 5, the image 502 shows a cat and a dog, and the model identified a “cat” and a “dog” concept. As discussed above, the dog concept was identified with a high confidence score of 0.90 (which satisfied rule R_102 of the rules datastore 500) and, as a result, the concept was written as a “SUCCESS” annotation. As such, the annotation of “dog” does not allow the user to accept or reject it (although in some embodiments such a capability may be provided). The “cat” concept was identified with a lower confidence score of 0.65 (which did not satisfy the success rule of R_101 but did satisfy the “pending” rule of R_101). As a result, the “cat” concept was presented to a user in the user interface 500 as a potential annotation. If the user agrees, the user may interact with the interface to “accept” the pending annotation. The user selection can be submitted by interacting with a submit button 506 or other user interface elements. Once the pending annotation is submitted, it is added as an annotation associated with the input. Further, pursuant to some embodiments, the user's acceptance of the pending annotation may be used to train the model to further improve model performance. Additionally, in some embodiments, the user's acceptance of the pending annotation may further be used to train or modify one or more threshold models or rule (e.g., to modify one or more of the thresholds 608, actions 610 or the like).

In some embodiments, a user may easily interact with the user interface 500 to quickly accept the pending annotations of the system 100. Further, in some embodiments, the user may choose to create or update additional annotations via the interface 500 (e.g., via menu items or other user interface elements not shown in FIG. 5).

Reference is now made to FIG. 4 where a flow diagram depicting a annotation workflow process 400 is shown. Process 400 may be executed on or in conjunction with annotation platform 120 of FIG. 1 to produce an output such as the user interface 500 of FIG. 5. Process 400 begins at 402 where an input is identified (e.g., such as the next image to be processed) and is provided to a workflow (which may consist of one or more models or other rules or applications). For simplicity and ease of exposition, the model will be described as being a model (such as the classification model described elsewhere herein). Processing continues at 404 where the output from the model 304 is identified. In an example where the model 304 is a classification model, the output may include one or more predicted concepts as well as one or more associated confidence scores. Processing at 404 may also include interacting with a mapper (such as the mapper 306 of FIG. 3) to map the concepts from the model 402 to concepts in the workflow.

Each of the concepts or outputs from the model 304 (or from the mapper 306) are processed at 406 to determine whether a threshold is met. For example, the concepts and scores (or other information) are presented as inputs to one or more threshold models (shown as items 308, 310 of FIG. 3). In some embodiments, if no threshold is met, process continues at 408 where the concept is added to a worker queue for display to a user (e.g., via a user interface such as the user interface 500 of FIG. 5). For example, if in the illustrative example introduced above, the model identified the concept of a “bowl” (as shown in the input image 502 of FIG. 5), but no rules were established regarding the concept “bowl”, then processing may proceed to 408 where the concept of “bowl” may be added to a worker queue for display to a user (and the user can adopt or discard the concept). In some embodiments, if processing at 406 indicates that no threshold is met, rather than adding the concept to the worker queue at 408, the concept may simply be ignored so that the user is not bothered to review the concept.

Processing continues at 410 where the user may interact with a user interface to accept, ignore, modify or otherwise provide some annotation input. Once the annotation input has been provided, processing may continue at 402 where a next input to the workflow (or model) may be provided. In some embodiments, processing may also continue at 412 where the annotation input received from the user at 410 may be used to further train the model. In some embodiments, particularly where an annotation rule has been proposed as “pending” (e.g., at block 418), the user's acceptance of the pending annotation may be used to further validate a model and improve the training of the model at 412. In some embodiments, the acceptance (or rejection) of the pending annotation may further be used to train or otherwise update one or more threshold models 308, 310 to improve their ability to automatically annotate inputs.

If processing at 406 determines that a threshold applies to the concept and score received at 404, a further determination is made whether the score is satisfies a SUCCESS threshold (e.g., a threshold such as the threshold 608 identified as R_101 in table 600 of FIG. 6). If so, processing continues at 416 as the system automatically writes the annotation as a “SUCCESS”, and the annotation is stored in association with the input as an output of the system 100. The concept and score associated with the input may also be presented as an input to other threshold models which may include a PENDING threshold. For example, a threshold such as the threshold 608 identified as R_103 in the table 600 may be met which will cause an action to be taken to write as “PENDING” the concept as a proposed annotation. Processing continues at 420 where the concept is written as a pending annotation and the concept and score are added to the worker queue at 408 for display to a user as proposed annotations.

If the confidence score does not satisfy any thresholds, the concept and confidence score may be provided to the worker queue at 408 (without any pending annotation). Alternatively, the concept may be ignored. In this manner, embodiments allow inputs to be automatically annotated or tagged based on the output of one or more models if the model provides a high degree of confidence in the output. Outputs with a lower degree of confidence may be written as pending annotations prompting further review, and outputs with even lower degrees of confidence may be simply passed to a user interface for a user to annotate. The result are annotation workflows that are highly efficient and accurate.

While statuses labeled “SUCCESS” and “PENDING” have been used to describe features of some embodiments, those statuses and labels are purely for illustrative purposes and other statuses and labels may be used. Further, while rules with two or three ranges of scores have been described, other variations and ranges may be used.

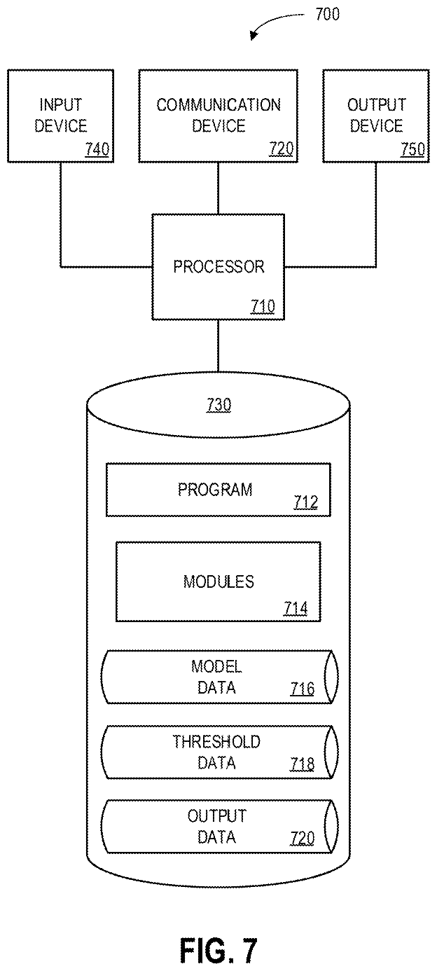

The embodiments described herein may be implemented using any number of different hardware configurations. For example, FIG. 7 illustrates an annotation platform 700 that may be, for example, associated with the system 100 of FIG. 1 as well as the other systems and components described herein. The annotation platform 700 comprises a processor 710, such as one or more commercially available central processing units (CPUs) in the form of microprocessors, coupled to a communication device 720 configured to communicate via a communication network (not shown in FIG. 7). The communication device 720 may be used to communicate, for example, with one or more input sources and/or user devices. The annotation platform 700 further includes an input device 740 (e.g., a mouse and/or keyboard to define rules and relationships) and an output device 750 (e.g., a computer monitor to display reports and results to an administrator).

The processor 710 also communicates with a storage device 730. The storage device 730 may comprise any appropriate information storage device, including combinations of magnetic storage devices (e.g., a hard disk drive), optical storage devices, mobile telephones, and/or semiconductor memory devices. The storage device 730 stores a program 712 and/or one or more software modules 714 (e.g., associated with the user interface module, model module, threshold module, and interface module of FIG. 1) for controlling the processor 710. The processor 710 performs instructions of the programs 712, 714, and thereby operates in accordance with any of the embodiments described herein. For example, the processor 710 may receive input data and then perform processing on the input data such as described in conjunction with the process of FIGS. 2 and 3. The programs 712, 714 may access, update and otherwise interact with data such as model data 716, threshold data 718 and output data 720 as described herein.

The programs 712, 714 may be stored in a compressed, uncompiled and/or encrypted format. The programs 712, 714 may furthermore include other program elements, such as an operating system, a database management system, and/or device drivers used by the processor 710 to interface with peripheral devices.

As used herein, information may be “received” by or “transmitted” to, for example: (i) the annotation platform 700 from another device; or (ii) a software application or module within the annotation platform 700 from another software application, module, or any other source.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A computer implemented method to perform an annotation workflow on an input, the method comprising:
receiving information associated with an output from a model, the output generated based on application of the model to the input, wherein the information comprises a first concept and an associated confidence score;
identifying a first threshold model that applies to the first concept;
determining that the confidence score associated with the first concept satisfies a threshold of the first threshold model;
writing the output based on an action specified by the first threshold model; and
updating an annotation user interface based on the action specified by the first threshold model.

2. The computer implemented method of claim 1, wherein the action is an action to write the output with a status.

3. The computer implemented method of claim 2, wherein the status is one of a pending and a success status.

4. The computer implemented method of claim 3, wherein the status is pending, wherein updating an annotation user interface further comprises:
displaying the information associated with the output as a proposed annotation for the input; and
receiving one of an acceptance and a rejection of the proposed annotation from a user.

5. The computer implemented method of claim 3, wherein the status is success, further comprising:
automatically converting the information associated with the output into an annotation associated with the input.

6. The computer implemented method of claim 5, wherein updating an annotation user interface further comprises:
displaying the annotation to the user.

7. The computer implemented method of claim 1, wherein the model is a classification model.

8. The computer implemented method of claim 1, wherein the information associated with the output includes a second concept and an associated second confidence score.

9. The computer implemented method of claim 8, wherein identifying a first threshold model includes identifying a first threshold model that applies to the first concept, the method further comprising:
identifying a second threshold model that applies to the second concept;
determining that the second confidence score satisfies a threshold of the second threshold model;
writing the output based on an action specified by the second threshold model; and
updating an annotation user interface based on the action specified by the second threshold model.

10. The computer implemented method of claim 8, further comprising:
identifying a second threshold model and a third threshold model that apply to the second concept;
determining that the second confidence score does not satisfy a threshold of the second threshold model;
determining that the second confidence score does not satisfy a threshold of the third threshold model; and
not writing the second concept as an annotation and not updating the annotation user interface to include the second concept.

11. The computer implemented method of claim 8, further comprising:
identifying a second threshold model and a third threshold model that apply to the second concept;
determining that the second confidence score does not satisfy a threshold of the second threshold model;
determining that the second confidence score does satisfies a threshold of the third threshold model;
writing the second concept as a pending annotation; and
updating the annotation user interface to propose the second concept as an annotation for acceptance by a user.

12. The computer implemented method of claim 11, further comprising:
adding the pending annotation to a worker queue for acceptance or rejection by a user.

13. The computer implemented method of claim 11, further comprising:
adding the input and the pending annotation to a training data set for the model upon confirmation from the user.

14. A system comprising:
a processing unit; and
a memory storage device including program code that when executed by the processing unit causes to the system to:
receive information associated with an output from a model, the output generated based on application of the model to the input, wherein the information comprises a first concept and an associated confidence score;
identify a first threshold model that applies to the first concept;
determine that the confidence score associated with the first concept satisfies a threshold of the first threshold model;
write the output based on an action specified by the first threshold model; and
update an annotation user interface based on the action specified by the first threshold model.

15. The system of claim 14, wherein the model is a classification model.

16. The system of claim 15, wherein the information associated with the output includes a second concept and an associated second confidence score.

17. The system of claim 16, wherein identifying a first threshold model includes identifying a first threshold model that applies to the first concept, the system further comprising program code that when executed by the processing unit causes to the system to:
identify a second threshold model that applies to the second concept;
determine that the second confidence score satisfies a threshold of the second threshold model;
write the output based on an action specified by the second threshold model; and
update an annotation user interface based on the action specified by the second threshold model.

18. The system of claim 16, further comprising program code that when executed by the processing unit causes to the system to:
identify a second threshold model and a third threshold model that apply to the second concept;
determine that the second confidence score does not satisfy a threshold of the second threshold model;
determine that the second confidence score does not satisfy a threshold of the third threshold model; and
not write the second concept as an annotation and not updating the annotation user interface to include the second concept.

19. The system of claim 16, further comprising program code that when executed by the processing unit causes to the system to:
identify a second threshold model and a third threshold model that apply to the second concept;
determine that the second confidence score does not satisfy a threshold of the second threshold model;
determine that the second confidence score does satisfies a threshold of the third threshold model;
write the second concept as a pending annotation; and
update the annotation user interface to propose the second concept as an annotation for acceptance by a user.
